(19) United States
(12) Patent Application Publication
(10) Pub. No.: US 2022/0103112 A1
(43) Pub. Date: Mar. 31, 2022

(54) METHOD AND DEVICE FOR ACTUATING AN ELECTRIC MACHINE, AND ELECTRIC DRIVE SYSTEM

(71) Applicant: Robert Bosch GmbH, Stuttgart (DE)

(72) Inventor: Thomas Zeltwanger, Ingersheim (DE)

(21) Appl. No.: 17/425,432

(22) PCT Filed: Jan. 13, 2020
(86) PCT No.: PCT/EP2020/050623

§ 371 Date: Jul. 23, 2021

(30) Foreign Application Priority Data
Jan. 25, 2019 (DE) 10 2019 200 919.0

(51) Int. Cl. H02P 27/08; B60L 53/20; B60L 15/20

(52) U.S. Cl. CPC H02P 27/085; B60L 15/20; B60L 53/20

(57) ABSTRACT

The invention relates to the actuation of an electric machine with a change between time-synchronous PWM clocking and angle-synchronous block clocking It is proposed to provide an angle-synchronous clocking with adjustable voltage indicator length for the transition. In this way, jumps in the operating behavior of the electric machine can be minimized or optionally prevented completely during a change between time-synchronous clocking and angle-synchronous clocking.

### BACKGROUND OF THE INVENTION

The present invention relates to a method for actuating an electric machine. The present invention further relates to a device for actuating an electric machine and an electric drive system with a device of this type.

Electric drive systems are becoming increasingly important. For example, modern electric drive systems are required for drive systems of vehicles which are fully or partially electrically driven. In the case of an electric drive which is used in an electric vehicle, for example, an electric machine is powered by a multiphase alternating voltage. This alternating voltage can be provided by an electric power converter, for example. This electric power converter can, for example, be powered by a direct voltage source such as a traction battery of an electric vehicle, for example. For generating the alternating voltage, a modulation of the direct voltage thus takes place, in order to produce a desired rotational frequency and/or a desired torque at the electric machine. This alternating voltage is generated by switching power switches in the power converter on and off, for example. In this case, different modulation methods can be used. In particular, a distinction is made between time synchronous and angle synchronous methods. In the case of a time synchronous method, a voltage signal can be modulated by means of pulse width modulation (PWM), for example. In this case, each power switch of the power converter is switched on and off a maximum of one time per PWM period. In the case of an angle synchronous method, the power switches are switched on and off one or several times per period depending on the electrical angle of the machine.

Printed document EP 1 441 436 A1 discloses a control system with a hardware unit for controlling an electric machine. In particular, the electric machine can be controlled selectively in PWM or block operation.

### SUMMARY OF THE INVENTION

The present invention discloses a method for actuating an electric machine, a device for actuating an electric machine and an electric drive system with the features of the independent claims. Further advantageous embodiments are the subject matter of the dependent claims.

Accordingly, provision is made for:

a method for actuating an electric machine including the steps of actuating the electric machine in a first operating mode using a time synchronous clocking with a predetermined maximum first voltage vector length, a step for actuating the electric machine in a second operating mode using an angle synchronous clocking with an adjustable second voltage vector length and a step for actuating the electric machine in a third operating mode using an angle synchronous block clocking with a predetermined third voltage vector length.

Provision is further made for:

a device for actuating an electric machine with a power converter and a control device. The power converter is designed to be coupled to an electric machine. The power converter is further designed to provide an electric voltage actuating the electric machine. In particular, the power converter is designed to provide the electric voltage using control signals from the control device. The control device is electrically coupled to the power converter. Furthermore, the control device is designed to provide control signals for actuating the power converter.

In particular, the control device is designed to actuate the electric machine in a first operating mode using a time synchronous clocking with a predetermined maximum first voltage vector length. Furthermore, the control device is designed to actuate the electric machine in a second operating mode using an angle synchronous clocking with an adjustable second voltage vector length. Finally, the control device is designed to actuate the electric machine in a third operating mode using an angle synchronous block clocking with a predetermined third voltage vector length. In particular, the predetermined third voltage vector length can in this case be specified in a constant and fixed manner.

Finally, provision is made for:

an electric drive system having a device according to the invention for actuating the electric machine and an electric machine which is electrically coupled to the power converter of the device for actuating the electric machine.

The underlying knowledge of the present invention is that different actuation methods are possible for actuating electric machines. In particular, the alternating voltages for actuating an electric machine can be generated using a time synchronous clocking or alternatively using an angle synchronous clocking. In this case, different actuation methods can be advantageous depending on the operating state. The further underlying knowledge of the present invention is that a transition between a PWM synchronous clocking and an angle synchronous block clocking presents a challenge.

One idea of the present invention is therefore to take this knowledge into account and to create an actuation for an electric machine which enables an improved transition between a PWM synchronous and an angle synchronous clocking.

For the most optimal operation possible, provision is made to use three different operating modes for generating the electric voltages for actuating the electric machine. In a first operating mode, the electric voltages for actuating the electric machine can be generated using a time synchronous clocking, in particular a PWM clocking. A clocking of this type makes it possible, especially for smaller voltage vectors up to a certain maximum voltage vector length, to control very effectively the output voltages or output currents in a power converter for actuating the electric machine. Moreover, a time synchronous clocking of this type is in particular advantageous for only slowly rotating or even stationary electric machines. In contrast, for very high output voltages, in particular in the case of high motor speeds, an angle synchronous clocking, in particular an angle synchronous block clocking is advantageous for generating the electric voltages in the power converter for actuating the electric machine.

Owing to theoretical and practical limits, pulse width modulated methods only achieve a modulation index <1. The higher the adjustable modulation index, the higher the voltage yield of the voltage modulation at the electric motor at the same battery voltage. The set modulation index is a normalized value which results directly from the voltage vector length. It is defined as the quotient of the voltage vector length and the voltage amplitude during block operation. In the case of block operation, the voltage amplitude corresponds to the available input voltage, the battery voltage. For example, a maximum modulation index of approximately 0.907 can currently be achieved with conventional PWM methods without overmodulation. In contrast, during block operation in the case of angle synchronous block clocking, the modulation index is 1. In the case of a direct transition from a PWM synchronous clocking to an angle synchronous block clocking, this difference in the modulation index must therefore be overcome abruptly. However, a transition of this type has an acoustically, electrically and also mechanically negative effect on the overall system.

In order to avoid this abrupt transition, provision is therefore made according to the invention to provide a further operating mode for the transition between time synchronous PWM clocking and angle synchronous block clocking, in which operating mode clocking takes place in an angle synchronous manner with an adjustable voltage vector length. Any angle synchronous control methods which permit a variation of the voltage vector length are, in principle, possible for this purpose. In particular, a triple middle pulse clocking can be used, for example, which is explained in greater detail hereinafter.

By using an angle synchronous clocking with adjustable voltage vector length, the modulation index can in particular be continuously adapted from the limited modulation index of a time synchronous PWM clocking to the modulation index of 1 of the angle synchronous block clocking. In this way, jumps can be avoided.

According to one embodiment, a transition between actuating the electric machine in the first operating mode and actuating the electric machine in the third operating mode takes place by means of actuating the electric machine in the second operating mode. As already mentioned previously, a continuous transition between the maximum voltage vector length during the time synchronous clocking in the first operating mode and the voltage vector length in the case of the angle synchronous block clocking can be achieved by an angle synchronous clocking with a variably adjustable voltage vector length. This makes it possible to improve the operating behavior of the electric drive system when transitioning between time synchronous clocking and block clocking.

According to one embodiment, during the transition from the first operating mode to the third operating mode, the adjustable second voltage vector length is continuously controlled from the predetermined maximum first voltage vector length for the time synchronous clocking to the predetermined third voltage vector length of the angle synchronous block clocking. A continuous transition between the time synchronous clocking and the angle synchronous block clocking can be achieved by continuously adapting the adjustable second voltage vector length. In particular, jumps can thus be avoided. This has a positive effect on both the mechanical behavior and on the acoustic properties.

According to one embodiment, the second operating mode comprises a middle pulse triple clocking. In the case of a middle pulse triple clocking, starting from a block clocking, two further switching processes can be provided. The two additional switching processes can take place symmetrically relative to the middle of the block, for example. In this way, a single block of a block clocking is divided into two symmetrical sub-blocks, wherein the total length of the two sub-blocks is shorter than the block length of a block during the block clocking. In this way, an angle synchronous clocking with reduced voltage vector length can be achieved.

According to one embodiment, the pulse width of the middle pulse of the middle pulse triple clocking is adjusted using the adjustable second voltage vector length. In this case, the second voltage vector length can be adapted by varying the pulse width of the middle pulse. In particular, the voltage vector length can be reduced in comparison to the maximum achievable voltage vector length in the case of block clocking.

According to one embodiment, a transition from the second operating mode to the third operating mode takes place if the pulse width of the middle pulse of the middle pulse triple clocking falls below a predetermined minimum pulse width. The minimum pulse width defines the time which may not be fallen short of, meanwhile a switch element of the power converter is switched on and off or correspondingly vice versa. In this case, the minimum pulse width can be specified, for example as a result of the component properties, in particular the properties of the switch elements, in a power converter. Moreover, dead times or further characteristic parameters may also optionally be taken into account for specifying the minimum pulse width.

According to one embodiment, during a transition from the third operating mode to the first operating mode, the adjustable second voltage vector length in the second operating mode is continuously controlled from a predetermined third voltage vector to the predetermined maximum first voltage vector. In this way, a continuous, constant transition from the angle synchronous block clocking to the time synchronous PWM clocking can also be achieved.

In one embodiment, the second synchronous clocking comprises a pulse width modulation.

The previous configurations and developments can be combined with one another as desired, as far as is reasonable. Further configurations, developments and implementations of the invention also include combinations, which are not explicitly specified, of features of the invention described previously or hereinafter with respect to the exemplary embodiments. In particular, the person skilled in the art shall also add individual aspects as improvements or supplements to the respective basic forms of the present invention.

### BRIEF DESCRIPTION OF THE DRAWINGS

The present invention is explained in greater detail hereinafter using the exemplary embodiments specified in schematic figures of the drawings. The following are shown therein:

FIG. 1: shows a schematic representation of a block diagram of an electric drive system according to one embodiment;

FIG. 2: shows a schematic representation of a time synchronous clocking;

FIG. 3: shows a schematic representation of an angle synchronous block clocking;

FIG. 4: shows a schematic representation of an angle synchronous clocking for an adjustable voltage vector length; and

FIG. 5: shows a schematic representation of a flow diagram as it is based on a method for actuating an electric machine according to one embodiment.

### DETAILED DESCRIPTION

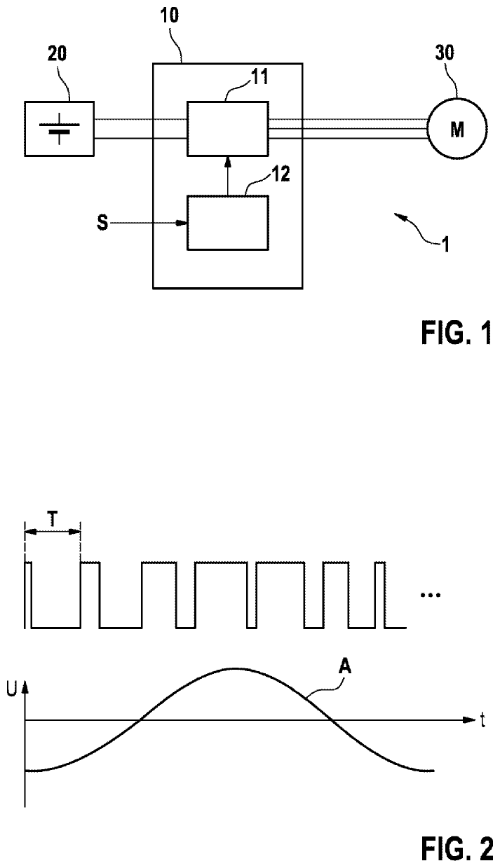

FIG. 1 shows a schematic representation of a block diagram of an electric drive system 1 having a device 10 for actuating an electric machine 30. The electric drive system 1 comprises an electric machine 30 which can be powered by a power converter 11, for example. For this purpose, the power converter 11 can be powered by a direct voltage source such as a battery 30, or the like, for example. The example represented here of a three-phase electric machine 30 serves only for better understanding and in this case does not represent any limitation of the present invention. Moreover, any electric machines 30 with a number of electrical phases which deviates from three are, of course, also possible. For example, it can also be a six-phase electric machine 30 or an electric machine 30 with any other number of phases. In order to actuate the electric machine 30, the power converter 11 can convert the direct voltage provided by the battery 20 into a suitable alternating voltage. In the case of a three-phase electric machine 30, the power converter 11 can transform the direct voltage into a three-phase alternating voltage, for example. In this case, the amplitude of the alternating voltage and/or the value of the output current from the power converter 11 to the electric machine 30 can in particular be adjusted on the basis of a predetermined set point S. The power converter 11 can be a power converter with a plurality of half bridges, for example. In particular, the power converter 11 can comprise at least one half bridge with two switch elements for each phase of the electric machine 30. The power converter 11 can therefore have a B6 topology for a three-phase electric machine 30, for example. The switch elements of the power converter 11 can in this case be actuated by the control device 12 by means of the suitable control signals using the set point value S. In this case, the control device 12 can provide a control signal for each switch element of the power converter 11, for example, in order to open or to close the corresponding switch element. In the subsequent description, the control signal for one switch element of the switch elements of a power converter 11 is in particular described. The control signals of the remaining switch elements are formed in the same way. In this case, the actuation of an upper switch element of a half bridge takes place in a complementary manner to the actuation of the corresponding lower switch element. Moreover, dead times or the like may also be taken into account.

FIG. 2 shows a schematic representation of an actuating signal of a time synchronous clocking for actuating a switch element in a power converter 11 for actuating the electric machine 30. In order to facilitate understanding, only a few pulses are represented in this case for one period of the output signal. As can be identified in FIG. 2, the actuation of the switch element in the power converter 11 takes place on the basis of a fixed time pattern with the period duration T. Within each time pattern, the corresponding switch element is switched on and off a maximum of one time. The voltage level of the output signal can be adjusted accordingly by varying the ratio between the duty cycle and switch-off time. For example, the period duration T of a cycle can be 100 μs, so that the clock frequency of the signal is 10 kHz. Moreover, any other period durations T or clock frequencies are, of course, also possible. As can be further identified in FIG. 2, depending on the duty cycle of a pulse, there results a corresponding voltage level of the output signal A.

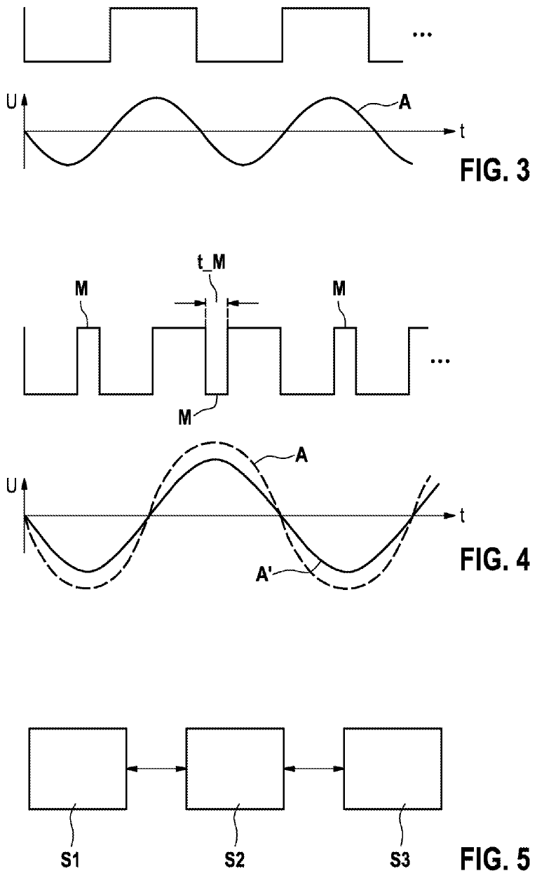

FIG. 3 shows a schematic representation of a control signal for actuating a switch element in the power converter 11 for an angle synchronous block clocking. As can be identified here, the corresponding switch element is switched on for half of a period duration T of the output signal and is switched off for a further half of a period duration. In this case, the period duration T varies depending on the frequency of the output signal A. Moreover, however, the amplitude of the output signal A cannot be influenced in the case of an angle synchronous block clocking.

FIG. 3 shows a schematic representation of a control signal for a semiconductor switch element of a power converter 11 for an angle synchronous clocking with adjustable voltage vector length, in particular for a middle pulse triple clocking. Here too, the period duration T depends on the frequency of the output signal A. The middle pulse triple clocking differs from the block clocking described in FIG. 3 in that for each half wave of the output signal A, two further switching processes are provided. In this case, a switch-on and a switch-off process is provided symmetrically relative to the middle of half of a period duration in each case. These additional switch-on or switch-off processes in each case create a middle pulse M with a pulse width t_M at the middle of a block in the range of drive system voltage vector length π/4 and 3π/4 in each case. This middle pulse M results in the amplitude of the output signal A in the case of a middle pulse triple clocking being lower than the amplitude of an output signal A′, as would be the case with an angle synchronous block clocking. For the purpose of better illustration, the output signal A according to the middle pulse triple clocking is represented as a continuous line, and the output signal A′ of an angle synchronous block clocking is represented as a dashed line.

By varying the pulse width t_M of the middle pulse M, the voltage vector length can thus be varied.

During actual operation, it is not possible in this case to select an arbitrarily short time between a switch-on process and a resulting switch-off process or a switch-off process and a resulting switch-on process. In fact, predefined framework conditions must be adhered to in this case. It is therefore also not possible to select the pulse width t_M of the middle pulse M to be arbitrarily short. If the voltage vector is to be increased within the scope of the control of an electric machine 30, for example, the pulse width t_M of the middle pulse M is therefore increasingly reduced in the case of a time synchronous clocking. In this case, if the pulse width t_M of the middle pulse M achieves the minimum adjustable pulse width, there follows a direct transition to the angle synchronous block clocking without a middle pulse M, as has been described previously in connection with FIG. 3. Conversely, if the voltage vector length is to be reduced within the scope of control, a transition can only be made from the angle synchronous block clocking to the middle pulse triple clocking if the middle pulse M has a pulse width t_M which has at least the required middle pulse width.

Depending on the operating state, it is possible to change between the actuation methods described above for operating the electric drive system with the electric machine 30. In particular when the electric machine 30 is in the stationary state or has low rotational speeds, the actuation preferably takes place based on a time synchronous clocking according to the pulse width modulated clocking described in connection with FIG. 2. In this case, the time synchronous clocking based on the PWM method generally only enables a modulation up to a modulation rate of approximately 0.907. The modulation rate can optionally be increased slightly by the use of an overmodulation. Nevertheless, an overmodulation of this type is also associated with disadvantages, such that it may not be desirable.

On the other hand, the angle synchronous block clocking as it has been described in connection with FIG. 3 has a modulation rate of 1. Correspondingly, this angle synchronous block clocking is also connected to a fixed voltage vector. In the case of a direct transition from the time synchronous pulse width modulated clocking to the angle synchronous block clocking, the difference of the modulation rate from the maximum of the PWM clocking to the block clocking must therefore be overcome abruptly.

In order to avoid a jump of this type, an angle synchronous clocking with variable voltage vector length can take place during the transition, as has been described in an exemplary manner in connection with FIG. 3.

In this case, a time synchronous PWM clocking can firstly take place for actuating the electric machine 30, for example. A time synchronous PWM clocking of this type can take place up to a predetermined maximum voltage vector length, for example. Starting from the PWM clocking, if a transition is to be made to an angle synchronous clocking, an angle synchronous clocking with variable voltage vector length firstly takes place, for example a middle pulse triple clocking, as has been described in connection with FIG. 4. However, in principle, other actuation methods are also possible for an angle synchronous clocking with variable voltage vector length. In this case, by varying the pulse width t_M of the middle pulse M, the voltage vector length can be varied. If applicable, it should be taken into account in this case that the rotational speed of the electric machine has a sufficiently high electrical frequency, as is required for an angle synchronous clocking. In the further process, the voltage vector length can be continuously adapted and in particular increased during the angle synchronous clocking. If the voltage vector length reaches an upper limit value during the angle synchronous clocking, it is possible to transition to the angle synchronous block clocking relatively easily without a middle pulse. This can in particular take place if the pulse width t_M of the middle pulse M falls below a predetermined minimum pulse width.

Analogously, it is possible to change to the angle synchronous clocking, for example the middle pulse triple clocking described in FIG. 4, starting from the angle synchronous block clocking, wherein the middle pulse must also have at least the required minimum pulse width in this case. As a result, the voltage vector length can be continuously varied and in particular reduced until a transition to a time synchronous PWM clocking becomes possible. Of course, it is also possible to continuously respond to required controller changes during operation in the angle synchronous clocking with variable voltage vector length. In this way, the voltage vector length can be adapted to the requirements, for example.

It is therefore possible, after changing from the PWM clocking to the angle synchronous clocking with variable voltage vector length, to also return to the PWM clocking without having previously changed to the angle synchronous block clocking, for example. Accordingly, it is also possible to change from the angle synchronous block clocking to the angle synchronous clocking with variable voltage vector length and subsequently back to the angle synchronous block clocking without a time synchronous PWM clocking having taken place in the interim.

FIG. 5 shows a schematic representation of a flow diagram, as it is based on a method for actuating an electric machine according to one embodiment. In step S 1, an actuation of the electric machine 30 takes place in a first operating mode. In the first operating mode, the actuation of the electric machine takes place using a time synchronous clocking with a predetermined maximum first voltage vector length. In step S3, the actuation of the electric machine takes place in a third operating mode. In the third operating mode, the actuation of the electric machine takes place using an angle synchronous block clocking with a predetermined third voltage vector length. The transition between the first operating mode and the third operating mode can take place by actuating S2 the electric machine 30 in a second operating mode. In the second operating mode, the actuation of the electric machine 30 takes place using an angle synchronous clocking with an adjustable second voltage vector length.

In this case, the first voltage vector length is determined in particular by the maximum modulation rate of the time synchronous clocking. The third voltage vector length for the angle synchronous block clocking results from the input voltage of the power converter 11, for example. Moreover, the second voltage vector length can fluctuate between the maximum first voltage vector length and the third voltage vector length in the angle synchronous block clocking operation, for example. Owing to the required minimum pulse width, the maximum achievable voltage vector length for the angle synchronous clocking with variable voltage vector length can optionally be slightly smaller than the third voltage vector length in the angle synchronous block clocking.

In summary, the present invention relates to actuating an electric machine with a change between time synchronous PWM clocking and angle synchronous block clocking. For this purpose, it is proposed that an angle synchronous clocking with adjustable voltage vector length is provided for the transition. This makes it possible to minimize or optionally completely prevent jumps in the operating behavior of the electric machine when changing between time synchronous clocking and angle synchronous clocking.

1. A method for actuating an electric machine (30), the method comprising the following steps:
actuating (S1) the electric machine (30) in a first operating mode using a time synchronous clocking with a predetermined maximum first voltage vector length;
actuating (S2) the electric machine (30) in a second operating mode using an angle synchronous clocking with an adjustable second voltage vector length; and
actuating (S3) the electric machine (30) in a third operating mode using an angle synchronous block clocking with a predetermined third voltage vector length.

2. The method as claimed in claim 1, wherein a transition between actuating (S1) the electric machine (30) in the first operating mode and actuating (S3) the electric machine (30) in the third operating mode takes place by means of actuating (S2) the electric machine (30) in the second operating mode.

3. The method as claimed in claim 2, wherein during the transition from the first operating mode to the third operating mode, the adjustable second voltage vector length is continuously controlled from the predetermined maximum first voltage vector length to the predetermined third voltage vector length.

4. The method as claimed in claim 1, wherein the second operating mode comprises a middle pulse triple clocking.

5. The method as claimed in claim 4, wherein a pulse width (t_M) of a middle pulse is adjusted using the adjustable second voltage vector length.

6. The method as claimed in claim 1, wherein a transition from the second operating mode to the third operating mode takes place if the pulse width (t_M) of the middle pulse falls below a predetermined minimum pulse width.

7. The method as claimed in claim 1, wherein during a transition from the third operating mode to the first operating mode, in the second operating mode the adjustable second voltage vector length is continuously controlled from the predetermined third voltage vector length to the predetermined maximum first voltage vector length.

8. The method as claimed in claim 1, wherein the time synchronous clocking comprises a pulse width modulation.

9. A device (10) for actuating an electric machine (30), having:
a power converter (11) which is configured to be coupled to an electric machine (30) and to provide an electric voltage for actuating the electric machine (30); and
a control device (12) which is electrically coupled to the power converter (11) and which is configured to provide control signals for actuating the power converter (11),
wherein the control device (12) is configured
to actuate the electric machine (30) in a first operating mode using a time synchronous clocking with a predetermined maximum first voltage vector length,
to actuate the electric machine (30) in a second operating mode using an angle synchronous clocking with an adjustable second voltage vector length, and
to actuate the electric machine (30) in a third operating mode using an angle synchronous block clocking with a predetermined third voltage vector length.

10. An electric drive system (1), comprising: a power converter (11) which is configured to be coupled to an electric machine (30) and to provide an electric voltage for actuating the electric machine (30); and
a control device (12) which is electrically coupled to the power converter (11) and which is configured to provide control signals for actuating the power converter (11), wherein the control device (12) is further configured
to actuate the electric machine (30) in a first operating mode using a time synchronous clocking with a predetermined maximum first voltage vector length,
to actuate the electric machine (30) in a second operating mode using an angle synchronous clocking with an adjustable second voltage vector length, and
to actuate the electric machine (30) in a third operating mode using an angle synchronous block clocking with a predetermined third voltage vector length, and an electric machine (30) which is electrically coupled to the power converter (11) of the device (10) for actuating the electric machine (30).
